(19) United States
(12) Patent Application Publication
(10) Pub. No.: US 2024/0230939 A1
(43) Pub. Date: Jul. 11, 2024

(54) GEOBODIES EXTRACTION TECHNIQUE THROUGH SEISMIC ATTRIBUTES

(71) Applicant: SAUDI ARABIAN OIL COMPANY, Dhahran (SA)

(72) Inventor: Abdullah ALWUSAIBIE, Dhahran (SA)

(73) Assignee: SAUDI ARABIAN OIL COMPANY, Dhahran (SA)

(21) Appl. No.: 18/153,174

(22) Filed: Jan. 11, 2023

(51) Int. Cl. G01V 1/30

(52) U.S. Cl. CPC G01V 1/307; G01V 2210/63; G01V 2210/65; G01V 2210/66

(57) ABSTRACT

A method for identifying a prospective hydrocarbon deposit in a subterranean formation may include: providing (or acquiring) a plurality of section views for two seismic attributes corresponding to a portion of an interval of the subterranean formation; overlaying locationally corresponding section views for the two seismic attributes for each of the plurality of section views to produce a plurality of overlapping section views; extracting data points from each of the plurality of overlapping section views to correspondingly produce a plurality of cross-plots; and identifying a prospective hydrocarbon deposit by applying a cross-plot correlation between the two seismic attributes to the plurality of cross-plots where data points within the plurality of cross-plots encompassed by the cross-plot correlation locationally correspond to the prospective hydrocarbon deposit.

### FIELD OF THE DISCLOSURE

The present disclosure relates to oil and gas exploration, and more specifically, to the identification of prospective reservoir intervals within a subterranean formation for exploration and production activities.

### BACKGROUND OF THE DISCLOSURE

Hydrocarbon exploration is the search by geologists and geophysicists for deposits of hydrocarbons, particularly petroleum and natural gas. Visible surface features such as oil seeps and natural gas seeps sometimes provide evidence of hydrocarbon generation. However, most exploration depends on highly sophisticated technology to detect and determine the extent of these deposits using exploration geophysics. Gravity surveys, magnetic surveys, and seismic surveys can be used to detect large-scale features of subterranean formations. For example, seismic surveys may include acoustic impedance data that can be used to extrapolate porosity attributes of the formation. Because seismic data is complex, it can be difficult to visually and simultaneously analyze more than one seismic attribute. Therefore, individual seismic attributes are typically extrapolated to individual formation attributes that may be used in geo-body mapping techniques to identify prospective areas of hydrocarbon deposits where an exploration well may be drilled.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method may include: providing (or acquiring) a plurality of section views for two seismic attributes corresponding to a portion of an interval of a subterranean formation; overlaying locationally corresponding section views for the two seismic attributes for each of the plurality of section views to produce a plurality of overlapping section views; creating a first outline in each of the overlapping section views to encompass at least a portion of a hydrocarbon deposit; extracting data points from each of the plurality of overlapping section views to correspondingly produce a plurality of cross-plots having identified data points therein, wherein the identified data points are a portion of data points being encompassed by the first outline from the corresponding overlapping section views are identified in cach of the plurality of cross-plots; and producing a second outline that is the same for each of the plurality of cross-plots that encompasses at least a portion of the identified data points for each of the plurality of cross-plots, wherein the second outline is a cross-plot correlation between the two seismic attributes.

In another embodiment, a method may include: providing a plurality of section views for two seismic attributes corresponding to a portion of an interval of the subterranean formation; overlaying locationally corresponding section views for the two seismic attributes for each of the plurality of section views to produce a plurality of overlapping section views; extracting data points from each of the plurality of overlapping section views to correspondingly produce a plurality of cross-plots; and identifying a prospective hydrocarbon deposit by applying a cross-plot correlation between the two seismic attributes to the plurality of cross-plots where data points within the plurality of cross-plots encompassed by the cross-plot correlation locationally correspond to the prospective hydrocarbon deposit.

In a further embodiment, a machine-readable storage medium having stored thercon a computer program for identifying a prospective hydrocarbon deposit the computer program that includes a routine of set instructions for causing the machine to perform the steps of: receiving an input of a plurality of section views for two seismic attributes corresponding to a portion of an interval of the subterranean formation; overlaying locationally corresponding section views for the two seismic attributes for each of the plurality of section views to produce a plurality of overlapping section views; extracting data points from each of the plurality of overlapping section views to correspondingly produce a plurality of cross-plots; and identifying a prospective hydrocarbon deposit by applying a cross-plot correlation between the two seismic attributes to the plurality of cross-plots where data points within the plurality of cross-plots encompassed by the cross-plot correlation locationally correspond to the prospective hydrocarbon deposit

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is an example of a method of the present disclosure for identifying a cross-plot correlation between two seismic attributes.

FIG. 2 is an example of a method of the present disclosure for identifying prospective areas of hydrocarbon deposits within a subterranean formation using the cross-plot correlation of FIG. 1.

FIGS. 3A-3C illustrate an example of applying the methods of FIGS. 1 and 2 using seismic envelope and acoustic impedance for the seismic attributes.

FIG. 4 is a 3-dimensional model example of a potential output for displaying five prospective hydrocarbon deposits (or geo-bodies) within a subterranean formation.

FIG. 5 illustrates one example of a computer system that can be employed to execute one or more embodiments of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to methods and systems, including computer-implemented methods, computer-program products, and computer systems, to identify prospective reservoir intervals for exploration and production activities. More specifically, the methods and systems described herein relate to simultaneously evaluating two seismic attributes to delineate and extract prospective arcas of hydrocarbon deposits within a subterranean formation.

The methods and systems described herein include identifying a cross-plot correlation between the two seismic attributes that can then be readily applied to cross-plots of said two seismic attributes in other areas of a formation. The identification of the cross-plot correlation between the two seismic attributes may advantageously be performed using seismic data and exploration and production data from the formation. By analyzing the seismic data in light of the known outcomes from the exploration and production, the cross-plot correlation between the two seismic attributes may have high reliability when applied to other locations within the formation or in similar formations.

Further, as compared to other techniques that use seismic data for identifying potential hydrocarbon deposits, the cross-plot correlation between the two seismic attributes described herein is straightforward and does not require converting seismic data into formation attributes (e.g., porosity and permeability), which because said formation attributes may depend on several variable reduces the confidence in the derived formation attribute values. In contrast, the present disclosure identifies potential hydrocarbon deposits directly from seismic data.

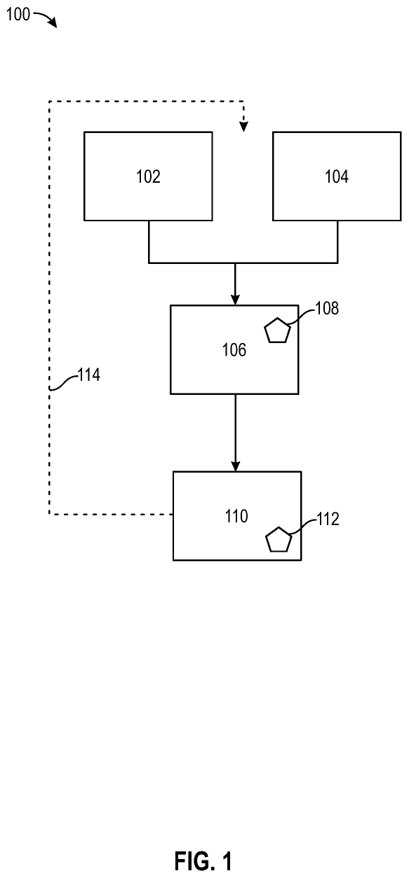

FIG. 1 is an example of a method 100 of the present disclosure for identifying a cross-plot correlation between the first and second seismic attributes that may be later used in identifying prospective areas of hydrocarbon deposits within a subterranean formation. Two seismic attributes for a portion (e.g., location, in-line section, and/or x-line section) of an interval of a subterranean formation are analyzed. Examples of seismic attributes may include, but are not limited to, seismic envelope, acoustic impedance, instantaneous phase, instantaneous frequency, apparent polarity, coherence, azimuth, dip, instantaneous amplitude, response amplitude, response phase, instantaneous bandwidth, amplitude versus offset, spectral decomposition, or any combination thereof. The envelope of seismic signals (or seismic envelope) is a phase-independent representation of amplitude of seismic signals.

A plurality of section views 102, 104 for each of the two seismic attributes within the portion of the interval of the subterranean formation being analyzed are manipulated by overlaying a section view 102 for the first seismic attribute with a second section view 104 of the second seismic attribute for a corresponding location within the formation to produce a plurality of overlapping section views 106. This overlaying is performed for the plurality of section views 102. 104. In cach of the overlapping section views 106, a first outline 108 (e.g., in the shape of a polygon, a circle, an oval, or a hybrid thereof) is created to encompass at least a portion of a hydrocarbon deposit (e.g., a known hydrocarbon deposit or a prospective hydrocarbon deposit) within the portion of interval of the subterranean formation. Determination of which portion of the overlapping section view 106 to encompass with the first outline 108 may be informed by knowledge of other portions of the interval of the subterranean formation and/or knowledge of other similar intervals within the same or another subterranean formation. For example, a general knowledge of the correspondence between acoustic impedance and seismic envelope that indicates a high probability of hydrocarbon deposits may be known from other exploration endeavors in the subterranean formation and/or a similar subterranean formation. This knowledge may be used to create the first outline 108. The first outline 108 in each of the overlapping section views 106 may not (and likely is not) the same. In another example, the first portion of the interval of the subterranean formation may have already been explored, where the seismic measurements were taken before exploration and production. Then, the correspondence between seismic attributes and hydrocarbon deposits may come directly from said exploration and production experience. In yet another example, other features of the overlapping section views 106 (e.g., a surface or rock facie bounding the interval) may be identified to provide a boundary of the first outline 108 and/or reference location within the overlapping section views 106 to which the first outline 108 may locationally relate (e.g., deeper than or shallower than said feature).

The first outline 108 may be determined or otherwise drawn by an operator, who may produce the first outline 108 alone or using guides, bounds, or other computer-assisted analytics. For example, the program or module used when producing the first outline 108 may have threshold bounds to limit the amount of area that can be encompassed, the magnitude or values of certain data points that may be encompassed, and the like. The threshold bounds may be such that the first outline 108 cannot violate said bounds or such that recommended shapes for the first outline 108 are built therefrom for an operator to amend, if needed.

Data points from the overlapping section views 106 are then extracted to produce a cross-plot 110 (a plot of a first seismic attribute vs. a second seismic attribute) where the data points from within the first outline 108 of the corresponding overlapping section view 106 are identified (e.g., highlighted and/or tagged). The cross-plot 110 with identified data points from the corresponding first outline 108 is produced for each of the overlapping section views 106. Then, the location of the identified data points is compared between the plurality of cross-plots 110 to determine how consistent the locations of the identified data points are in each of the plurality of cross-plots 110. The consistency between the identified data points from the corresponding first outline 108 in the plurality of cross-plots 110 may be determined by a variety of methods, which may include, but are not limited to, Bhattacharyya distance, overlapping coefficient, or any hybrid thereof.

If the locations have a low consistency between the various cross-plots 110, then the method 100 may restart 114 with a different combination for the two seismic attributes.

If the consistency in location of the data points corresponding to the first outline 108 across the plurality of cross-plots 108 is sufficiently high, a second outline 112 (e.g., in the shape of a polygon, a circle, an oval, or a hybrid thereof) may be created on the plurality of cross-plots 108 to encompass at least a portion of the identified data points corresponding to the first outline 108 for the plurality of cross-plots 110. The bounds of the second outline 112 may be assigned by a variety of methods. For example, the bounds of the second outline 112 may be set such that at least 70% (or at least 80%, or at least 90%) of the total data points (corresponding to from the first outline or not within the first outline) within the second outline 112 across the plurality of cross-plots 112 are from the data points identified as being within the first outline 108.

The second outline 112 is a cross-plot correlation between the first and second seismic attributes. The method 100 described in FIG. 1 may be iteratively performed to identify two seismic attributes with the best correlation (or two seismic attributes with sufficient correlation) to produce a cross-plot correlation 112 suitable for analyzing the same two seismic attributes for other locations, in-lines, and/or x-lines of the same or a similar subterranean formation.

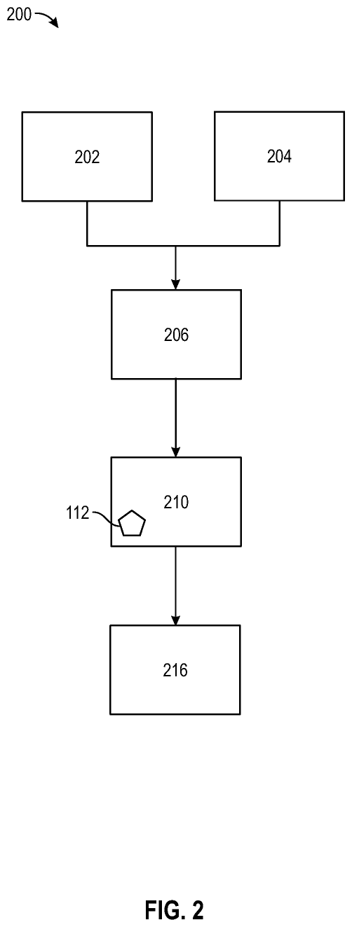

FIG. 2 is an example of a method 200 of the present disclosure for identifying prospective areas of hydrocarbon deposits within a subterranean formation using the cross-plot correlation 112 of FIG. 1. The method 200 uses a plurality of section views 202, 204 for each of the two seismic attributes that are used to produce the cross-plot correlation 112. The locationally corresponding section views 202, 204 are overlaid to produce a plurality of overlapping section views 206. Data points are extracted from the overlapping section views 206 to produce a cross-plot 210 where the cross-plot correlation 112 (i.e., the second outline 112) of FIG. 1 is used to identify data points in the cross-plot 210 that likely correspond to a prospective hydrocarbon deposit. Said data points within the cross-plot correlation 112, and their corresponding location in the subterranean formation, can then be used to identify prospective hydrocarbon deposits 216 for the subterranean formation. The prospective hydrocarbon deposits 216 (or geo-bodies) may be output (e.g., displayed in a 3-dimensional map or other suitable display) to facilitate placement of wells for expropriation and production of hydrocarbons.

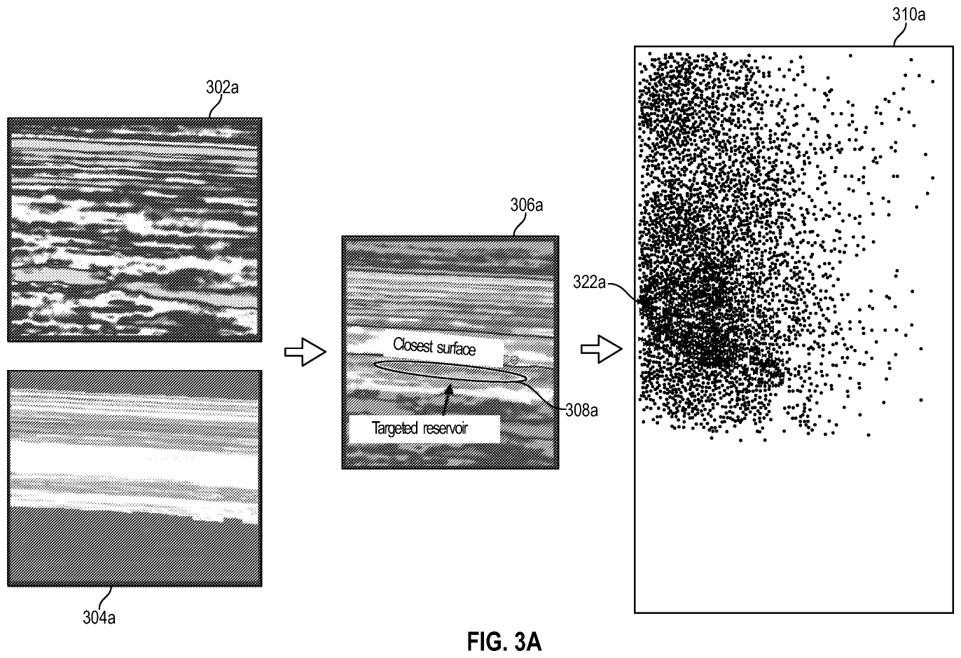

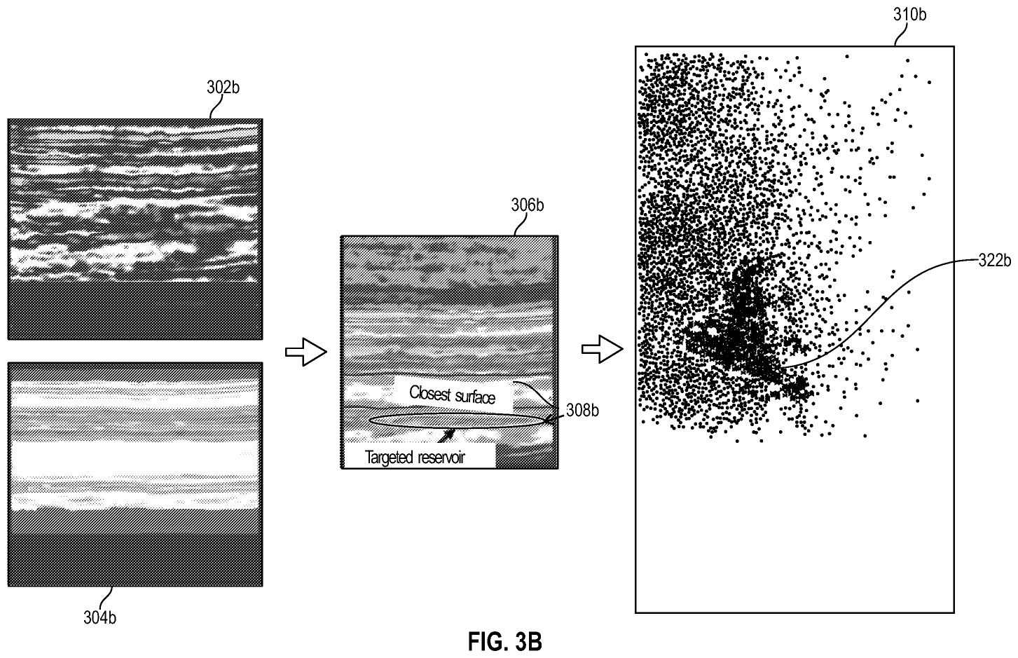

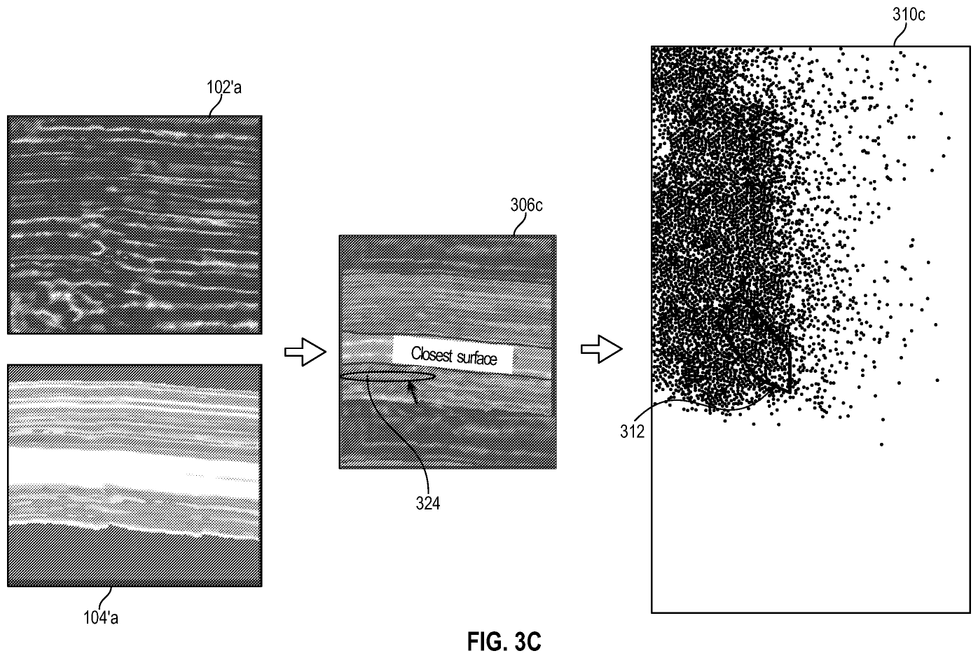

FIGS. 3A-3C illustrate an example of applying the methods of FIGS. 1 and 2 using seismic envelope and acoustic impedance as the seismic attributes. FIG. 3A illustrates a first section view 302a of seismic envelope data and a locationally corresponding first section view 304a of acoustic impedance data. The first section views 302a, 304a were overlaid to produce a first overlapping section view 306a. A first first outline 308a was drawn to encompass at least a portion of a hydrocarbon deposit within the portion of the interval of the subterranean formation. Then, a first cross-plot 310a was produced using the data points from the first overlapping section view 306a where the data points 322a (shown as Xs in the first cross-plot 310a of FIG. 3A) from within the first first outline 308a are identified.

Similarly, FIG. 3B illustrates a second section view 302b of seismic envelope data and a locationally corresponding second section view 304b of acoustic impedance data. The second section views 302b, 304b were overlaid to produce a second overlapping section view 306b. A second first outline 308b was drawn to encompass at least a portion of a hydrocarbon deposit within the portion of the interval of the subterranean formation. Then, a second cross-plot 310b was produced using the data points from the second overlapping section view 306b where the data points 322b (shown as Xs in the second cross-plot 310b of FIG. 3B) from within the second first outline 308b are identified.

The first and second identified data points 322a. 322b (along with the identified data points from other sections views similarly analyzed for the seismic envelope and acoustic impedance attributes) were locationally consistent across the cross-plots 310a, 310b (and the other cross-plots produced in said analysis). A second outline 312 (shown in FIG. 3C) was defined to encompass 90% of the identified data points.

FIG. 3C illustrates a third section view 302c of seismic envelope data and a locationally corresponding third section view 304c of acoustic impedance data. The third section views 302c, 304c were overlaid to produce a third overlapping section view 306c. Then, a third cross-plot 310c was produced using the data points from the third overlapping section view 306c. The cross-plot correlation 312 (i.e., the second outline produced using the identified data points 322a, 322b as discussed above) produced as described relative to FIGS. 2A-2B was used to identify data points within the formation that are prospective hydrocarbon deposits. In the illustration of FIG. 3C, the output is a section 324 in the overlapping section view 306c. Other outputs, including display in a 3-dimensional model, are suitable. In this example, the third section views 302c, 304c were from the same inline section as the first and second section views 302a, 304a, 302b, 304b to validate the methods of the present disclosure.

The output may include prospective hydrocarbon deposits (or geo-bodies) inside as well as outside the current reservoir limits because methods and systems described herein for correlating the two seismic attributes and applying the cross-plot correlation of the two seismic attributes are bounded by the location to which the seismic data is collected and not the current reservoir limits. Therefore, the output of the prospective hydrocarbon deposits may account for the current reservoir limits.

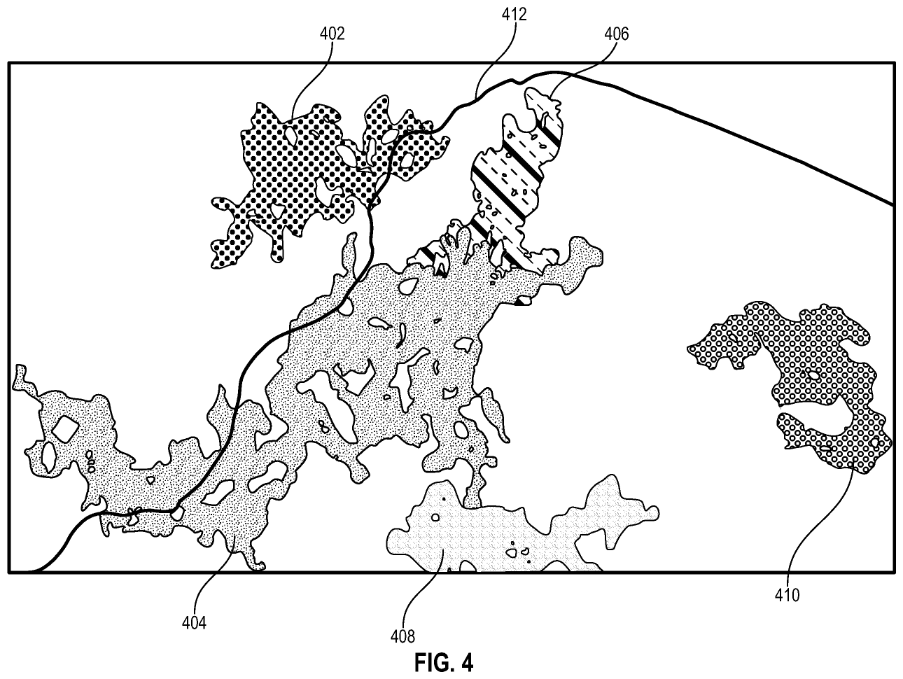

FIG. 4 is a 3-dimensional model 400 example of a potential output for displaying five prospective hydrocarbon deposits 402, 404, 406, 408, 410 (or geo-bodies) within a subterranean formation. The line 412 illustrates a reservoir limit.

Once one or more prospective hydrocarbon deposits are identified using the cross-plot correlation of the two seismic attributes described herein, a hydrocarbon exploration and/or production operation may be performed into at least one of the one or more prospective hydrocarbon deposits. Examples of exploration operations may include, but are not limited to, drilling, coring, logging, or any combination thereof. Examples of production operations may include, but are not limited to, producing hydrocarbons, fracturing and propping the formation, acidizing the formation, or any combination thereof.

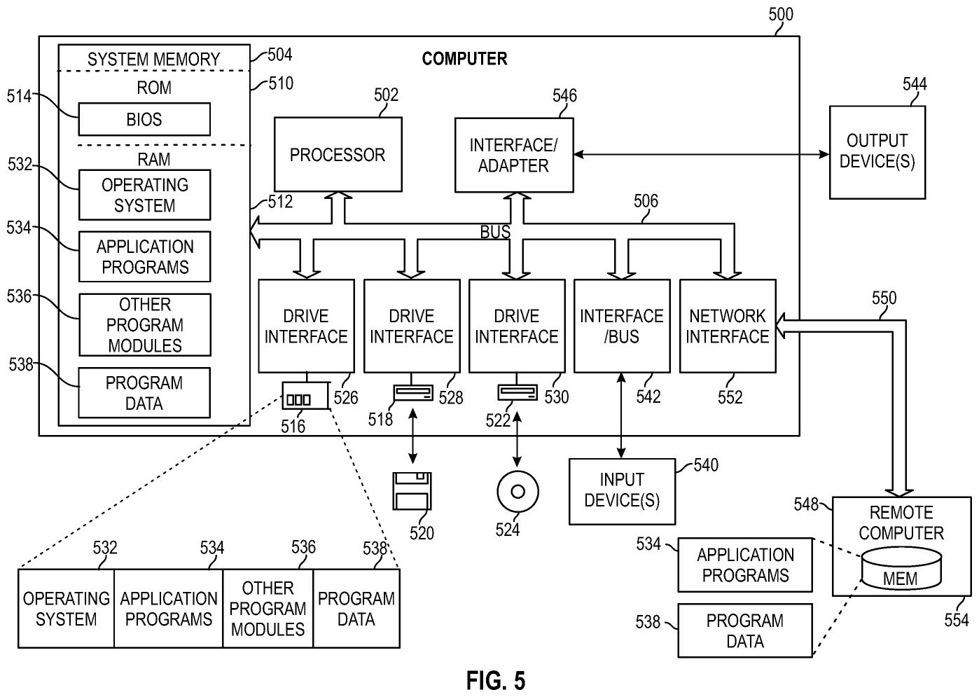

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 5. Furthermore, portions of the embodiments may be a computer program product on a computer-usable storage medium having computer readable program code on the medium. Any non-transitory, tangible storage media possessing structure may be utilized including. but not limited to, static and dynamic storage devices, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 5 illustrates one example of a computer system 500 that can be employed to execute one or more embodiments of the present disclosure. Computer system 500 can be implemented on one or more general purpose networked computer systems, embedded computer systems, routers, switches, server devices, client devices, various intermediate devices/nodes or standalone computer systems. Additionally, computer system 500 can be implemented on various mobile clients such as, for example, a personal digital assistant (PDA), laptop computer, pager, and the like, provided it includes sufficient processing capabilities.

Computer system 500 includes processing unit 502, system memory 504, and system bus 506 that couples various system components, including the system memory 504, to processing unit 502. Dual microprocessors and other multi-processor architectures also can be used as processing unit 502. System bus 506 may be any of several types of bus structure including a memory bus or memory controller, a peripheral bus, and a local bus using any of a variety of bus architectures. System memory 504 includes read only memory (ROM) 510 and random access memory (RAM) 512. A basic input/output system (BIOS) 514 can reside in ROM 510 containing the basic routines that help to transfer information among elements within computer system 500.

Computer system 500 can include a hard disk drive 516, magnetic disk drive 518, e.g., to read from or write to removable disk 520, and an optical disk drive 522, e.g., for reading CD-ROM disk 524 or to read from or write to other optical media. Hard disk drive 516, magnetic disk drive 518, and optical disk drive 522 are connected to system bus 506 by a hard disk drive interface 526, a magnetic disk drive interface 528, and an optical drive interface 530, respectively. The drives and associated computer-readable media provide nonvolatile storage of data, data structures, and computer-executable instructions for computer system 500. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 510, including operating system 532, one or more application programs 534, other program modules 536, and program data 538. In some examples, the application programs 534 can include overlaying programs. outlining programs (e.g., used to determine or otherwise draw the plurality of first outlines 108 of FIG. 1), consistency programs (or algorithms) (e.g., used when determining the second outline 112 of FIG. 1); and the program data 538 can include the seismic attribute data, overlaid section views, cross-plots, geo-body renderings, and other outputs to identify prospective hydrocarbon deposits produced by applying the cross-plot correlation described herein. The application programs 534 and program data 538 can include functions and methods programmed to perform various analyses or apply various algorithms described herein.

A user may enter commands and information into computer system 500 through one or more input devices 540, such as a pointing device (e.g., a mouse, touch screen), keyboard, microphone, joystick, game pad, scanner, and the like. For instance, the user can employ input device 540 to edit or modify the first outlines (e.g., the first outlines 108 of FIG. 1) and/or the choice of the two seismic attributes used in the analyses described herein. These and other input devices 540 are often connected to processing unit 502 through a corresponding port interface 542 that is coupled to the system bus, but may be connected by other interfaces, such as a parallel port, serial port, or universal serial bus (USB). One or more output devices 544 (e.g., display, a monitor, printer, projector, or other type of displaying device) is also connected to system bus 506 via interface 546, such as a video adapter.

Computer system 500 may operate in a networked environment using logical connections to one or more remote computers, such as remote computer 548. Remote computer 548 may be a workstation, computer system, router, peer device, or other common network node, and typically includes many or all the elements described relative to computer system 500. The logical connections, schematically indicated at 550, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 500 can be connected to the local network through a network interface or adapter 552. When used in a WAN networking environment, computer system 500 can include a modem, or can be connected to a communications server on the LAN. The modem, which may be internal or external, can be connected to system bus 506 via an appropriate port interface. In a networked environment, application programs 534 or program data 538 depicted relative to computer system 500, or portions thereof, may be stored in a remote memory storage device 554.

### Example Embodiments

Embodiments disclosed herein include, but are not limited to, the following.

Embodiment A. A method comprising: providing a plurality of section views for two seismic attributes corresponding to a portion of an interval of a subterranean formation; overlaying locationally corresponding section views for the two seismic attributes for each of the plurality of section views to produce a plurality of overlapping section views; creating a first outline in cach of the overlapping section views to encompass at least a portion of a hydrocarbon deposit; extracting data points from each of the plurality of overlapping section views to correspondingly produce a plurality of cross-plots having identified data points therein, wherein the identified data points are a portion of data points being encompassed by the first outline from the corresponding overlapping section views are identified in each of the plurality of cross-plots; and producing a second outline that is the same for each of the plurality of cross-plots that encompasses at least a portion of the identified data points for each of the plurality of cross-plots, wherein the second outline is a cross-plot correlation between the two seismic attributes.

Embodiment A may have one or more of the following additional elements in any combination: Element 1: wherein the two seismic attributes include one or more of: seismic envelope, acoustic impedance, instantaneous phase, instantaneous frequency, apparent polarity, coherence, azimuth, dip, instantaneous amplitude, response amplitude, response phase, instantaneous bandwidth, amplitude versus offset, and spectral decomposition; Element 2: method further comprising: providing a second plurality of section views for the two seismic attributes corresponding to a second portion of the interval of the subterranean formation or corresponding to a portion of a second interval of the subterranean formation; producing a second plurality of cross-plots for the second plurality of section views for the two seismic attributes; and identifying a prospective hydrocarbon deposit by applying the cross-plot correlation between the two seismic attributes to the second plurality of cross-plots where data points within the second plurality of cross-plots encompassed by the cross-plot correlation locationally correspond to the prospective hydrocarbon deposit; Element 3: Element 2 and the method further comprising: outputting the prospective hydrocarbon deposit in a 3-dimensional model; Element 4: Element 2 (or Element 2 and Element 3) and the method further comprising: performing a hydrocarbon exploration operation into the prospective hydrocarbon deposit; Element 5: wherein at least 70% of a total of the identified data points are within the second outline across the plurality of cross-plots are identified data points; Element 6: wherein at least 8% of a total of the identified data points are within the second outline across the plurality of cross-plots are identified data points; Element 7: wherein at least 90% of a total of the identified data points are within the second outline across the plurality of cross-plots are identified data points; Element 8: the method further comprising: calculating a consistency in location for the identified data points across the plurality of cross-plots; and if the consistency in location is low, performing the steps of overlaying, creating, and extracting with a different set of two seismic attributes; Element 9: Element 8 and wherein the consistency in location is based on a Bhattacharyya distance, an overlapping coefficient, or any hybrid thereof; Element 10: wherein at least some of the first outlines are a polygon; and Element 11: wherein the second outline is a polygon. By way of non-limiting example, exemplary combinations applicable to Embodiment A include: Element 1 with one or more of Elements 2-11; Element 2 (optionally with Element 3 or Element 4 or Elements 3 and 4) with one or more of Elements 5-11; Element 5 with one or more of Elements 6-11; Element 6 with one or more of Elements 7-11; Element 7 with one or more of Elements 8-11; Element 8 (optionally with Element 9) with one or more of Elements 10-11; and Element 10 with Element 11.

Embodiment B. A method comprising: providing a plurality of section views for two seismic attributes corresponding to a portion of an interval of the subterranean formation; overlaying locationally corresponding section views for the two seismic attributes for each of the plurality of section views to produce a plurality of overlapping section views; extracting data points from cach of the plurality of overlapping section views to correspondingly produce a plurality of cross-plots; and identifying a prospective hydrocarbon deposit by applying a cross-plot correlation between the two seismic attributes to the plurality of cross-plots where data points within the plurality of cross-plots encompassed by the cross-plot correlation locationally correspond to the prospective hydrocarbon deposit.

Embodiment C. A machine-readable storage medium having stored thercon a computer program for identifying a prospective hydrocarbon deposit the computer program comprising a routine of set instructions for causing the machine to perform the steps of: receiving an input of a plurality of section views for two seismic attributes corresponding to a portion of an interval of the subterranean formation; overlaying locationally corresponding section views for the two seismic attributes for each of the plurality of section views to produce a plurality of overlapping section views; extracting data points from each of the plurality of overlapping section views to correspondingly produce a plurality of cross-plots; and identifying a prospective hydrocarbon deposit by applying a cross-plot correlation between the two seismic attributes to the plurality of cross-plots where data points within the plurality of cross-plots encompassed by the cross-plot correlation locationally correspond to the prospective hydrocarbon deposit.

Each of Embodiments B through C may have one or more of the following additional clements in any combination: Element 12: wherein the two seismic attributes include one or more of: seismic envelope, acoustic impedance, instantaneous phase, instantaneous frequency, apparent polarity, coherence, azimuth, dip, instantaneous amplitude, response amplitude, response phase, instantaneous bandwidth, amplitude versus offset, and spectral decomposition; Element 13: the method further comprising (or the set of instructions further causing the machine to perform the steps of): outputting the prospective hydrocarbon deposit in a 3-dimensional model; and Element 14: the method further comprising (or the set of instructions further causing the machine to perform the steps of): performing a hydrocarbon exploration operation into the prospective hydrocarbon deposit.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, clements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for clements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method comprising:
providing a plurality of section views for two seismic attributes corresponding to a portion of an interval of a subterranean formation;
overlaying locationally corresponding section views for the two seismic attributes for each of the plurality of section views to produce a plurality of overlapping section views;
creating a first outline in each of the overlapping section views to encompass at least a portion of a hydrocarbon deposit;
extracting data points from each of the plurality of overlapping section views to correspondingly produce a plurality of cross-plots having identified data points therein, wherein the identified data points are a portion of data points being encompassed by the first outline from the corresponding overlapping section views are identified in each of the plurality of cross-plots; and
producing a second outline that is the same for each of the plurality of cross-plots that encompasses at least a portion of the identified data points for each of the plurality of cross-plots, wherein the second outline is a cross-plot correlation between the two seismic attributes.

2. The method of claim 1, wherein the two seismic attributes include one or more of: seismic envelope, acoustic impedance, instantaneous phase, instantaneous frequency, apparent polarity, coherence, azimuth, dip, instantaneous amplitude, response amplitude, response phase, instantaneous bandwidth, amplitude versus offset, and spectral decomposition.

3. The method of claim 1 further comprising:
providing a second plurality of section views for the two seismic attributes corresponding to a second portion of the interval of the subterranean formation or corresponding to a portion of a second interval of the subterranean formation;
producing a second plurality of cross-plots for the second plurality of section views for the two seismic attributes; and
identifying a prospective hydrocarbon deposit by applying the cross-plot correlation between the two seismic attributes to the second plurality of cross-plots where data points within the second plurality of cross-plots encompassed by the cross-plot correlation locationally correspond to the prospective hydrocarbon deposit.

4. The method of claim 3 further comprising:
outputting the prospective hydrocarbon deposit in a 3-dimensional model.

5. The method of claim 3 further comprising:
performing a hydrocarbon exploration operation into the prospective hydrocarbon deposit.

6. The method of claim 1, wherein at least 70% of a total of the identified data points are within the second outline across the plurality of cross-plots are identified data points.

7. The method of claim 1, wherein at least 8% of a total of the identified data points are within the second outline across the plurality of cross-plots are identified data points.

8. The method of claim 1, wherein at least 90% of a total of the identified data points are within the second outline across the plurality of cross-plots are identified data points.

9. The method of claim 1 further comprising:
calculating a consistency in location for the identified data points across the plurality of cross-plots; and
if the consistency in location is low, performing the steps of overlaying, creating, and extracting with a different set of two seismic attributes.

10. The method of claim 9, wherein the consistency in location is based on a Bhattacharyya distance, an overlapping coefficient, or any hybrid thereof.

11. The method of claim 1, wherein at least some of the first outlines are a polygon.

12. The method of claim 1, wherein the second outline is a polygon.

13. A method comprising:
providing a plurality of section views for two seismic attributes corresponding to a portion of an interval of the subterranean formation;
overlaying locationally corresponding section views for the two seismic attributes for each of the plurality of section views to produce a plurality of overlapping section views;
extracting data points from each of the plurality of overlapping section views to correspondingly produce a plurality of cross-plots; and
identifying a prospective hydrocarbon deposit by applying a cross-plot correlation between the two seismic attributes to the plurality of cross-plots where data points within the plurality of cross-plots encompassed by the cross-plot correlation locationally correspond to the prospective hydrocarbon deposit.

14. The method of claim 13, wherein the two seismic attributes include one or more of: seismic envelope, acoustic impedance, instantaneous phase, instantaneous frequency, apparent polarity, coherence, azimuth, dip, instantaneous amplitude, response amplitude, response phase, instantaneous bandwidth, amplitude versus offset, and spectral decomposition.

15. The method of claim 13 further comprising:
outputting the prospective hydrocarbon deposit in a 3-dimensional model.

16. The method of claim 13 further comprising:
performing a hydrocarbon exploration operation into the prospective hydrocarbon deposit.

17. A machine-readable storage medium having stored thereon a computer program for identifying a prospective hydrocarbon deposit the computer program comprising a routine of set instructions for causing the machine to perform the steps of:
receiving an input of a plurality of section views for two seismic attributes corresponding to a portion of an interval of the subterranean formation;
overlaying locationally corresponding section views for the two seismic attributes for each of the plurality of section views to produce a plurality of overlapping section views;
extracting data points from each of the plurality of overlapping section views to correspondingly produce a plurality of cross-plots; and
identifying a prospective hydrocarbon deposit by applying a cross-plot correlation between the two seismic attributes to the plurality of cross-plots where data points within the plurality of cross-plots encompassed by the cross-plot correlation locationally correspond to the prospective hydrocarbon deposit.

18. The machine-readable storage medium of claim 17, wherein the two seismic attributes include one or more of: seismic envelope, acoustic impedance, instantaneous phase, instantaneous frequency, apparent polarity, coherence, azimuth, dip, instantaneous amplitude, response amplitude, response phase, instantaneous bandwidth, amplitude versus offset, and spectral decomposition.

19. The machine-readable storage medium of claim 17, wherein the set of instructions further causing the machine to perform the steps of:
outputting the prospective hydrocarbon deposit in a 3-dimensional model.

20. The machine-readable storage medium of claim 17, wherein the set of instructions further causing the machine to perform the steps of:
causing a system to perform at least a portion of a hydrocarbon exploration operation into the prospective hydrocarbon deposit.
